(19) United States
(12) Patent Application Publication
(10) Pub. No.: US 2021/0192316 A1
(43) Pub. Date: Jun. 24, 2021

(54) DEVICE AND METHOD FOR PROCESSING DIGITAL DATA

(71) Applicant: Robert Bosch GmbH, Stuttgart (DE)

(72) Inventors: Jannik Stroetgen, Karlsruhe (DE); Marvin Schiller, Heimsheim (DE)

(21) Appl. No.: 17/111,069

(22) Filed: Dec. 3, 2020

(30) Foreign Application Priority Data
Dec. 20, 2019 (DE) 102019220410.4

(51) Int. Cl. G06N 3/04; G06N 3/08

(52) U.S. Cl. CPC G06N 3/04; G06N 3/08

(57) ABSTRACT

A computer-implemented method for processing digital data of a specific domain, the digital data including a multitude of data sequences, a respective data sequence including in each case multiple data elements, and the data elements, following a logical and/or syntactic structure being joined together to form the respective data sequence. The method encompasses the following steps: parsing a respective data sequence into multiple components utilizing its logical and/or syntactic structure, providing vector representations of the components, determining degrees of similarity between individual vector representations and determining degrees of similarity between individual data sequences based on degrees of similarity between individual vector representations.

### CROSS REFERENCE

The present application claims the benefit under 35 U.S.C. § 119 of German Patent Application No. DE 102019220410.4 filed on Dec. 20, 2019, which is expressly incorporated herein by reference in its entirety.

### FIELD

The present invention is directed to a device and to a method for processing digital data, in particular, using an artificial neural network.

### BACKGROUND INFORMATION

Methods for processing data are used, for example, in duplicate detection and/or similarity detection. Near-duplicate detection, for example, refers to a field in information retrieval that involves locating identical or nearly identical texts in a volume of data. One sample application is the locating of websites that include identical or nearly identical contents. This is of interest, in particular, for locating plagiarism and copyright infringements. Conventional methods, for example, analyze the similarities of texts on the text surface. The conventional methods are, in principle, divided into word surface-based methods, which operate solely at the word/character level, and semantic methods, which also analyze the meaning of words.

### SUMMARY

The present invention relates to a computer-implemented method for processing digital data of a specific domain, the digital data including a multitude of data sequences, a respective data sequence including in each case multiple data elements, and the data elements being joined together following a logical and/or syntactic structure to form the respective data sequence. In accordance with an example embodiment of the present invention, the method encompasses the following steps:

parsing a respective data sequence utilizing its logical and/or syntactic structure into multiple components, providing vector representations of the components, determining degrees of similarity between individual vector representations and determining degrees of similarity between individual data sequences based on the degrees of similarity between individual vector representations.

A data sequence is understood here to mean multiple data elements joined together following a logical and/or syntactic structure. A single data element, for example, is a word or a character, or a unit made up of one or multiple words and/or of one or multiple characters.

According to one preferred specific embodiment of the present invention, the digital data include a volume of texts, in particular, at the sentence level. According to one preferred specific embodiment of the present invention, the texts include requirement specifications, one data sequence corresponding to one requirement statement. Such a requirement statement advantageously includes a logical and/or a syntactic structure. The description provides parsing a single data sequence into multiple components utilizing its logical and/or syntactic structure. The syntactic and logical characteristics of requirement statements are utilized, in particular, in order to parse complex units, for example, “if X, then Y” into smaller units, for example, X and Y. In this case, the order of the data elements and/or a semantic composition, in particular, is/are significant. For example, the significance of a requirement statement is a function of whether a data element is assigned to a condition, for example, “if”, or to a confirmation, for example, “then”.

Vector representations are subsequently provided for the individual components. Vector representations of words (word embeddings) are projections of words into a continuous, multidimensional vector space. For example, a suitable model, in particular a neural network, is used for providing the vector representations. The semantic and syntactic similarities of words in the representations remain advantageously unchanged. Degrees of similarity between individual vector representations may be determined based on the vector representations with the aid of simple distance measures, for example, cosine similarity.

To provide the words as vectors, a method may be used in which individual words are represented as vectors. However, it is also possible that a method is used in which multiple words, in particular, entire sentences, are represented as a shared vector.

The degrees of similarity are advantageously determined with the aid of a similarity function. Limiting values, which degrees of similarity are yet referred to as “duplicates”, may be advantageously established in an application-specific manner.

Degrees of similarity between individual data sequences are subsequently determined based on the degrees of similarity between individual vector representations. The description utilizes the fact that a representation in the vector space for smaller units is more easily and accurately achievable. The similarities of complete requirement statements are then determined based on the similarities of the smaller units. The method further utilizes a previous knowledge about the peculiarities and/or the structure of requirement statements. The method functions according to a so-called divide-and-conquer principle. In this case, the actual—in its entirety—complex problem is parsed into smaller and more easily solvable sub-problems. A solution for the entire problem is then constructed or reconstructed from these sub-solutions. “Divide and conquer” is one of the most important principles for efficient algorithms. This principle utilizes the fact that the solution effort in many problems decreases if the problem is parsed into smaller sub-problems.

According to one specific embodiment of the present invention, the determination of similarities between individual data sequences further encompasses: concatenating components using the logical and/or syntactic structure to form a respective data sequence. The degree of similarity between individual data sequences then results by combining the degrees of similarity between the individual components.

According to one specific embodiment of the present invention, the provision of vector representations of components further encompasses: integrating pieces of domain-specific information. Thus, pieces of domain-specific information are advantageously integrated into the model for providing the vector representations.

According to one specific embodiment of the present invention, the pieces of domain-specific information include concepts from a domain ontology of the specific domain. A vector representation of the components is advantageously expanded using the model by integrating pieces of information from the domain ontology, for example, pieces of information about the type of concepts. In this way, for example, it is possible to combine standard vectors including pieces of type information and/or pieces of superior class information to form individual domain-specific words that are derived from the domain ontology.

According to one specific embodiment of the present invention, the method further encompasses: creating rules based on the logical structure of a data sequence and/or based on the syntactic structure of a data sequence. The rules may be predefined by a domain expert. The rules include, for example, logical patterns, for example, “if A, then B”, “B only, if A”, “not C, if A and B”.

According to one specific embodiment of the present invention, the data sequences are parsed using at least one rule.

According to one specific embodiment of the present invention, the data sequences are parsed using a model for automatically identifying the syntactic structure, in particular, a dependency parser. The syntactic structure is then advantageously analyzed if no suitable rule, in particular, no logical pattern, for a data sequence is found. With the aid of a dependency parser, a syntactic analysis is automatically carried out in order to be able to represent the syntax of the data sequence as a dependency tree. Emanating from a root node, so-called root, of the tree, a partitioning into individual components may then take place.

According to one specific embodiment of the present invention, the vector representations are provided using a model, in particular, a neural network, the model having been trained, in particular, using a volume of domain-specific data. By integrating domain knowledge, it is possible to learn a robust model even with little training data.

According to one specific embodiment of the present invention, the method further encompasses: training the model using a volume of domain-specific data. The model is advantageously trained using domain-specific data. The domain-specific data advantageously include the data sequences, in particular, requirement statements, as well as additional further texts of the domain. Integrating additional further texts enhances the robustness of the model.

According to one specific embodiment of the present invention, the method further encompasses: outputting a resulting data stream, the resulting data stream including a collection of data sequences grouped, in particular, according to degrees of similarity.

Further specific embodiments of the present invention relate to a device for processing digital data, the digital data including a multitude of data sequences, a respective data sequence including in each case multiple data elements, and the data elements, following a logical and/or syntactic structure, being joined together to form the respective data sequence, the device being designed to carry out the method according to the specific embodiments.

According to one specific embodiment of the present invention, the device includes at least one processor and one memory for a neural network, which are designed to carry out the method according to the specific embodiments of the present invention.

Further specific embodiments of the present invention relate to a computer program, the computer program including computer-readable instructions, during the execution of which on a computer, a method runs according to the specific embodiments.

The method and/or the device according to the specific embodiments of the present invention may be used in the area of information retrieval for the automatic detection of duplicates and near-duplicates, in particular, in texts that include a plurality of requirement statements. Based on this, it is possible to execute and/or process the requirements more efficiently.

The method according to the specific embodiments of the present invention may improve conventional models for automatically detecting duplicates and near-duplicates in data, in particular in texts, by utilizing both the syntactic structure and/or logical structure as well as domain-specific knowledge.

### BRIEF DESCRIPTION OF THE DRAWINGS

Further advantageous specific embodiments of the present invention result from the description below and the figures. Identical or similar objects are provided with the same reference numerals.

FIG. 1 shows steps in a method for processing data according to one specific embodiment of the present invention.

FIG. 2 schematically shows a representation of a device for processing data according to one specific embodiment of the present invention.

### DETAILED DESCRIPTION OF EXAMPLE EMBODIMENTS

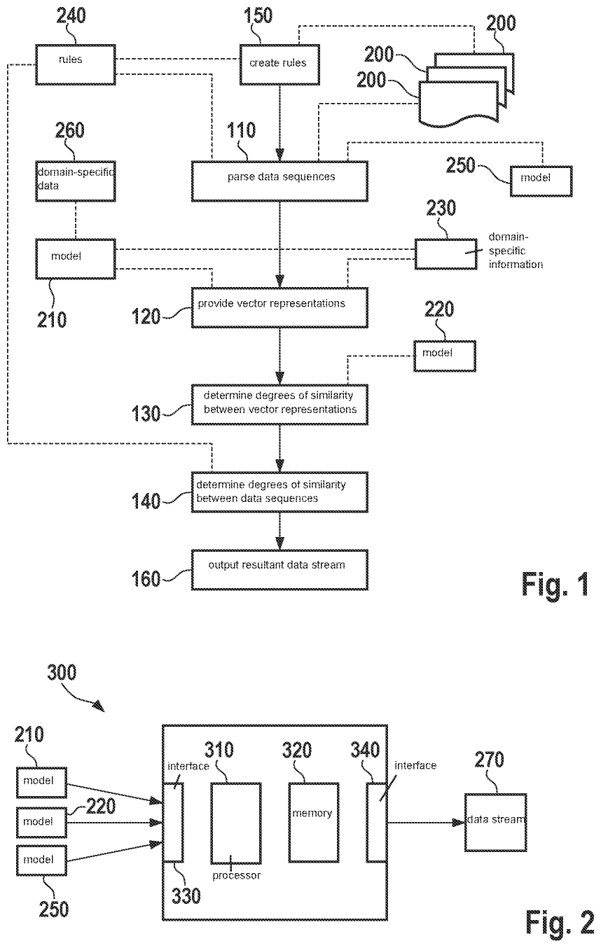

FIG. 1 schematically shows a representation of steps in a method 100 for processing digital data. FIG. 1 further includes a schematic representation of data and pieces of information, which are processed in method 100 according to the present invention. Data flows are depicted as dashed lines in FIG. 1.

The digital data include a multitude of data sequences 200, a respective data sequence including in each case multiple data elements, and the data elements, following a logical and/or syntactic structure, being joined together to form the respective data sequence. A single data element is, for example, a word or a character, or a unit made up of one or multiple word(s) and/or of one or multiple character(s).

According to one specific embodiment of the present invention, the digital data include a volume of texts, in particular, at the sentence level. According to one preferred specific embodiment, the texts include requirement specifications (requirement), one data sequence 200 corresponding to one requirement statement. Such a requirement statement advantageously includes a logical and/or syntactic structure.

In a step 110, a data sequence 200 is parsed into multiple components utilizing its logical and/or syntactic structure. The syntactic and logical characteristics of requirement statements are utilized, in particular, in order to parse complex units, for example, “if X, then Y”, into smaller units, for example, X and Y. In this case, the order of the data elements and/or a semantic composition is/are significant. For example, the significance of a requirement statement is a function of whether a data element is assigned to a condition, for example, “if” or to a confirmation, for example, “then”.

Vector representations of the components are provided in a step 120.

Vector representations of words (word embeddings) are projections of words into a continuous multidimensional vector space. For example, a suitable model 210, in particular, a neural network, is used for providing 120 the vector representations. The semantic and syntactic similarities of words in the representation remain advantageously unchanged. Conventional examples for models 210 are, for example, the model “word2vec”, which calculates a vector for each individual word, or the models “sentence2vec” described, for example, at https://github.com/stanleyfok/sentence2vec, and “doc2vec”, described, for example, at https://deeplearning4j.org/docs/latest/deeplearning4j-nlp-doc2vec, which calculates, for example, the average vector sum of all words of a sentence.

In a step 130, degrees of similarity between individual vector representations are determined. The degrees of similarity are determined 130, for example, with the aid of simple distance measures, for example, cosine similarity. The degrees of similarity are advantageously determined using a model 220, which uses a similarity function. Limiting values, in particular, which degrees of similarity are still referred to as “duplicates”, may be established in an application-specific manner.

In a step 140, degrees of similarity between individual data sequences 200 are determined based on the degrees of similarity between individual vector representations. According to one specific embodiment, determination 140 of similarities between individual data sequences 200 further encompasses: concatenating components using the logical and/or syntactic structure to form a respective data sequence 200. The degree of similarity between individual data sequences 200 then results by combining the degrees of similarity between the individual components.

According to one specific embodiment of the present invention, provision 120 of vector representations of the components further encompasses: integrating pieces of domain-specific information 230. Thus, pieces of domain-specific information 230 are advantageously integrated into model 210 for providing the vector representations.

Pieces of domain-specific information 230 include, for example, pieces of information from a domain ontology of the specific domain. A vector representation of the components is advantageously expanded using model 210 by integrating pieces of information from the domain ontology, for example, pieces of information about the types of concepts. In this way, it is advantageously possible to combine standard vectors including pieces of type information and/or pieces of superior class information to form individual domain-specific words that are derived from the domain ontology.

In a step 150, rules 240 are created based on the logical structure of a data sequence 200 and/or based on the syntactic structure of a data sequence 200. Rules 240 may be predefined by a domain expert. Rules 240 include, for example, logical patterns, for example, “if A, then B”, “B only, if A”, “not C, if A and B”.

According to one specific embodiment of the present invention, data sequences 200 are parsed 110 using at least one rule 240.

Parsing 110 of data sequences 200 may also take place using a model 250 for automatically identifying the syntactic structure, in particular, a dependency parser. The syntactic structure is advantageously analyzed when no suitable rule 240, in particular, no logical pattern, for a data sequence is found. A syntactic analysis is automatically carried out with the aid of a dependency parser, in order to be able to represent the syntax of data sequence 200 as a dependency tree. Emerging from a root node, so-called root, of the tree, a partitioning into individual components may then take place.

Provision 120 of vector representations advantageously takes place using model 210, model 210 having been trained, in particular, using a volume of domain-specific data 260. By integrating domain knowledge 260, it is possible to learn a robust model 210 even with little training data.

The example method further advantageously encompasses a step for training the model using a volume of domain-specific data. This step is not depicted in FIG. 1. The model is advantageously trained using domain-specific data 260. Domain-specific data 260 advantageously include data sequences 200, in particular, requirement statements, as well as additional further texts of the domain. Integrating the additional further texts enhances the robustness of the model.

According to the specific embodiment depicted, method 100 encompasses a step 160 for outputting a resultant data stream 270, data stream 270 including a collection of data sequences grouped, in particular, according to degrees of similarity.

A main feature of the method is the decomposition of data sequences, in particular, requirement statements, into individual components, in particular, axioms, based on a logical and/or syntactic structure of the data sequences. In the case of texts in the area of requirement analysis, these data sequences include a multitude of requirement states. Patterns of such requirement statements are described by way of example below:

Pattern 1: [Condition][Subject][Action][Object][Constraint]

Pattern 2: [Condition][Action or Constraint][Value]

Pattern 3: [Subject][Action][Value].

One application example for the first pattern is the following sentence, for example: [If signal X is received (CONDITION)], [the system (SUBJECT) (should)] [set (ACTION)] [a signal receive bit (OBJECT)] [within two seconds (CONSTRAINT)].

Thus, the example method utilizes syntactic and/or logical characteristics of requirement statements, in order to parse a complex statement into smaller components. A representation in the vector space for smaller components is more easily and accurately achievable. The similarities of complete requirement statements are then determined based on the similarities of the components. In this step, rules 240 may be advantageously used again. For example, the combining to form similarities of the complete requirement statements may take place using rules 240.

FIG. 2 shows a device 300 for processing digital data, the digital data including a multitude of data sequences 200. This device 300 includes a processor 310 and a memory 320 for at least one artificial neural network 210, 220, 250. Device 300 in the example includes an interface 330 for an input of data and an interface 340 for an output of data.

Processor 310, memory 320 and interfaces 330, 340 are connected via suitable data lines not depicted. Processor 310 and memory 320 may be integrated into a microcontroller. Device 300 may also be designed as a distributed system. Device 300 is designed to carry out method 100 for processing digital data described with reference to FIG. 1.

The data provided by device 300 as input via the interface include, for example, data sequences 200 and/or pieces of domain-specific information 230 and/or domain-specific data 260, which include data sequences 200, in particular, requirement statements as well as additional further texts of the domain.

A data stream 270 resulting from the processing of data as an input of interface 330 is depicted in FIG. 2 as an output of interface 340.

What is claimed is:

1. A computer-implemented method for processing digital data of a specific domain, the digital data including a multitude of data sequences, each respective data sequence of the data sequences including multiple data elements, and the data elements, following a logical and/or syntactic structure, being joined together to form the respective data sequence, the method comprising the following steps:
parsing each respective data sequence of the data sequences, utilizing a logical and/or syntactic structure of the respective data sequence, into multiple components;
providing vector representations of the components;
determining degrees of similarity between individual vector presentations of the vector representations; and
determining degrees of similarity between individual data sequences of the data sequences based on the degrees of similarity between individual vector representations, wherein the determination of the degrees of similarity between the individual data sequences further includes concatenating components using the logical and/or the syntactic structure to form the respective data sequence.

2. The method as recited in claim 1, further comprising:
using a model including a neural network for creating the vector representations.

3. The method as recited in claim 1, wherein the providing of the vector representation of the components further includes integrating pieces of domain-specific information.

4. The method as recited in claim 3, wherein the pieces of domain-specific information include pieces of information from a domain ontology of a specific domain.

5. The method as recited in claim 1, further comprising:
creating rules based on the logical structure of a data sequence and/or based on the syntactic structure of each respective data sequence.

6. The method as recited in claim 5, wherein the data sequences are parsed using at least one of the created rules.

7. The method as recited in claim 6, wherein the data sequences are parsed using a model for automatically identifying the syntactic structure.

8. The method as recited in claim 1, wherein the vector representations are provided using a model including a neural network, the model having been trained using a volume of domain-specific data.

9. The method as recited in claim 8, further comprising:
training the model using a volume of domain-specific data.

10. The method as recited in claim 1, further comprising:
outputting a resulting data stream the resulting data stream including a collection of the data sequences grouped according to degrees of similarity.

11. A device for processing digital data, the digital data including a multitude of data sequences, each respective data sequence including multiple data elements, the data elements, following a logical and/or syntactic structure, being joined together to form the respective data sequence, the device configured to:
parse each respective data sequence of the data sequences, utilizing a logical and/or syntactic structure of the respective data sequence, into multiple components;
provide vector representations of the components;
determine degrees of similarity between individual vector presentations of the vector representations; and
determine degrees of similarity between individual data sequences of the data sequences based on the degrees of similarity between individual vector representations, wherein the determination of the degrees of similarity between the individual data sequences further includes concatenating components using the logical and/or the syntactic structure to form the respective data sequence.

12. The device as recited in claim 11, wherein the device includes at least one processor and one memory for a neural network.

13. A non-transitory machine-readable memory medium on which is stored a computer program for processing digital data of a specific domain, the digital data including a multitude of data sequences, each respective data sequence of the data sequences including multiple data elements, and the data elements, following a logical and/or syntactic structure, being joined together to form the respective data sequence, the computer program, when executed by a computer, causing the computer to perform the following steps:
parsing each respective data sequence of the data sequences, utilizing a logical and/or syntactic structure of the respective data sequence, into multiple components;
providing vector representations of the components;
determining degrees of similarity between individual vector presentations of the vector representations; and
determining degrees of similarity between individual data sequences of the data sequences based on the degrees of similarity between individual vector representations, wherein the determination of the degrees of similarity between the individual data sequences further includes concatenating components using the logical and/or the syntactic structure to form the respective data sequence.
